(19) United States
(12) Patent Application Publication
(10) Pub. No.: US 2025/0196668 A1
(43) Pub. Date: Jun. 19, 2025

(54) MULTI-STAGE CHARGING CONTROL

(71) Applicant: GM GLOBAL TECHNOLOGY OPERATIONS LLC, DETROIT, MI (US)

(72) Inventors: Philip James Prociw, Clinton Township, MI (US); Justin Anthony Bunnell, Farmington Hills, MI (US); Christopher Rowe, Hartland, MI (US); Ryan C. Mansfield, Madison Heights, MI (US)

(21) Appl. No.: 18/539,726

(22) Filed: Dec. 14, 2023

(51) Int. Cl. B60L 53/10; B60L 53/62; B60L 53/66

(52) U.S. Cl. CPC B60L 53/11; B60L 53/62; B60L 53/66

(57) ABSTRACT

Techniques are provided for multi-stage charging control of a vehicle. In one embodiment, the techniques involve determining a charging stage capability of a charging source, upon determining that the charging stage capability includes multi-stage charging, determining a first charging criteria, selecting a first charging circuit configuration based on the first charging criteria, where the first charging circuit configuration includes a first combination of cell groups of a rechargeable energy storage system of the vehicle, charging the rechargeable energy storage system via the first charging circuit configuration, determining a second charging criteria, selecting a second charging circuit configuration based on the second charging criteria, where the second charging circuit configuration includes a second combination of cell groups of the rechargeable energy storage system, and charging the rechargeable energy storage system via the second charging circuit configuration.

### INTRODUCTION

The subject disclosure relates to vehicle charging, and more specifically, to optimizing multi-stage direct current fast charging (DCFC) processes.

Multi-stage DCFC charging refers to a charging process for energy storage systems that applies different currents to a battery system to balance rapid charging goals with battery protection concerns. However, multi-stage DCFC charging processes do not typically involve control of circuit configurations of energy storage systems of the vehicles.

### SUMMARY

In one exemplary embodiment, a method is provided for multi-stage charging control of a vehicle. The method includes determining a charging stage capability of a charging source, upon determining that the charging stage capability includes multi-stage charging, determining a first charging criteria, selecting a first charging circuit configuration based on the first charging criteria, the first charging circuit configuration includes a first combination of cell groups of a rechargeable energy storage system of the vehicle, and charging the rechargeable energy storage system via the first charging circuit configuration.

In addition to one or more of the features described herein, the method also includes determining a second charging criteria, selecting a second charging circuit configuration based on the second charging criteria, the second charging circuit configuration includes a second combination of cell groups of the rechargeable energy storage system, and charging the rechargeable energy storage system via the second charging circuit configuration.

In addition to one or more of the features described herein, the charging source includes a charging station, another vehicle, a power bank, or a grid.

In addition to one or more of the features described herein, the first charging criteria includes at least one of: an available power of the charging source, present charging capabilities of the cell groups, a user charging duration limit, a user charging cost limit, a temperature of the rechargeable energy storage system, or an accessory load of the vehicle.

In addition to one or more of the features described herein, the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

In addition to one or more of the features described herein, the selection of the second charging circuit configuration is performed upon an occurrence of a transition event, the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

In addition to one or more of the features described herein, the first charging circuit configuration represents a 400 V parallel circuit configuration, and the second charging circuit configuration represents an 800 V series circuit configuration.

In another exemplary embodiment, a system is provided for multi-stage charging control of a vehicle. The system includes a processor, and memory or storage comprising an algorithm or computer instructions, which when executed by the processor, performs an operation. The operation includes determining a charging stage capability of a charging source, upon determining that the charging stage capability includes multi-stage charge, determining a first charging criteria, selecting a first charging circuit configuration based on the first charging criteria, the first charging circuit configuration includes a first combination of cell groups of a rechargeable energy storage system of the vehicle, and charging the rechargeable energy storage system via the first charging circuit configuration.

In addition to one or more of the features described herein, the operation also includes determining a second charging criteria, selecting a second charging circuit configuration based on the second charging criteria, the second charging circuit configuration includes a second combination of cell groups of the rechargeable energy storage system, and charging the rechargeable energy storage system via the second charging circuit configuration.

In addition to one or more of the features described herein, the charging source includes a charging station, another vehicle, a power bank, or a grid.

In addition to one or more of the features described herein, the first charging criteria includes at least one of: an available power of the charging source, present charging capabilities of the cell groups, a user charging duration limit, a user charging cost limit, a temperature of the rechargeable energy storage system, or an accessory load of the vehicle.

In addition to one or more of the features described herein, the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

In addition to one or more of the features described herein, the selection of the second charging circuit configuration is performed upon an occurrence of a transition event, the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

In addition to one or more of the features described herein, the first charging circuit configuration represents a 400 V parallel circuit configuration, and the second charging circuit configuration represents an 800 V series circuit configuration.

In yet another exemplary embodiment, a computer-readable storage medium having a computer-readable program code embodied therewith is provided for multi-stage charging control of a vehicle. The computer-readable program code is executable by one or more computer processors to perform an operation that includes determining a charging stage capability of a charging source, upon determining that the charging stage capability includes multi-stage charging, determining a first charging criteria, selecting a first charging circuit configuration based on the first charging criteria, the first charging circuit configuration includes a first combination of cell groups of a rechargeable energy storage system of the vehicle, and charging the rechargeable energy storage system via the first charging circuit configuration.

In addition to one or more of the features described herein, the operation also includes determining a second charging criteria, selecting a second charging circuit configuration based on the second charging criteria, the second charging circuit configuration includes a second combination of cell groups of the rechargeable energy storage system, and charging the rechargeable energy storage system via the second charging circuit configuration.

In addition to one or more of the features described herein, the first charging criteria includes at least one of: an available power of the charging source, present charging capabilities of the cell groups, a user charging duration limit, a user charging cost limit, a temperature of the rechargeable energy storage system, or an accessory load of the vehicle.

In addition to one or more of the features described herein, the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

In addition to one or more of the features described herein, the selection of the second charging circuit configuration is performed upon an occurrence of a transition event, the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

In addition to one or more of the features described herein, the first charging circuit configuration represents a 400 V parallel circuit configuration, the second charging circuit configuration represents an 800 V series circuit configuration, and the charging source includes a charging station, another vehicle, a power bank, or a grid.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle, according to an embodiment;

FIG. 2 illustrates a computing environment, according to an embodiment;

FIG. 3 illustrates a flowchart of a method of charging an energy storage system via a first charging circuit configuration, according to an embodiment; and

FIG. 4 illustrates a flowchart of a method of charging an energy storage system via a second charging circuit configuration, according to an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term “module” can refer to one or more algorithms, instruction sets, software applications, or other computer-readable program code that can be executed by a processor to perform the functions, operations, or processes described herein.

Embodiments of the present disclosure improve upon multi-stage DCFC techniques by providing a charging control module that structures or restructures charging circuit configurations of a rechargeable energy storage system (RESS). In one embodiment, the charging control module connects cell groups of the RESS, in series or in parallel, to provide a first charging circuit configuration based on a charging criteria. The RESS is then charged via the first charging circuit. Further, the charging control module can switch to second charging circuit configuration based on an updated charging criteria. The RESS can then be charged via the second charging circuit configuration.

One benefit of the disclosed embodiments is to improve charging speed by using suitable charging circuit configurations to adjust a system temperature in cooler climates. Further, embodiments of the present disclosure can use suitable charging circuit configurations to optimize charging in accordance with a user preference.

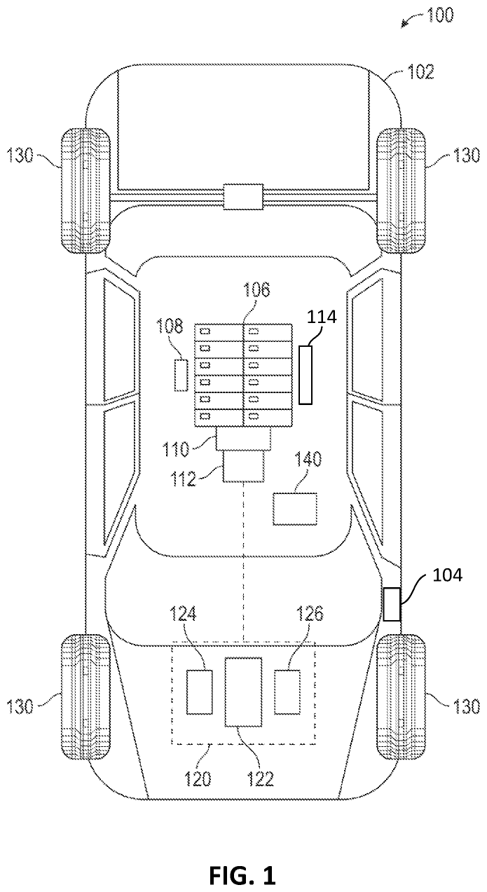

FIG. 1 illustrates a vehicle 100, according to an embodiment. The vehicle 100 includes a body 102, which can support a charge port 104, a power system 106, a sensor system 108, controlled contacts 114, and a propulsion system 120, a controller 140, and other systems of the vehicle 100 described herein.

In one embodiment, the vehicle 100 is an electric vehicle (EV) or a hybrid electric vehicle (HEV). In the illustrated embodiment, the vehicle 100 is an HEV that is partially powered by the power system 106, which includes multiple interconnected battery cells. The power system 106 is a rechargeable energy storage system (RESS) that can be charged via the charge port 104 that is connected to a charging source (e.g., a grid, a charging station, another vehicle, a power bank, or the like).

The power system 106 can be electrically coupled to at least one electric motor assembly of the propulsion system 120. In one embodiment, the power system 106 is electrically coupled to a direct current (DC) converter unit 110 (e.g., a DC-DC converter) and an inverter unit 112 (e.g., a traction power inversion unit). The inverter unit 112 can include multiple inverters that convert DC signals from the power system 106 to three-phase alternating current (AC) signals to drive electric motors of the propulsion system 120. The power system 106 can also be electrically coupled to vehicle electronics systems such as audio systems, display systems, navigation systems, temperature control systems, or the like.

The sensor system 108 includes a variety of sensors disposed on, or integrated with, various components of the vehicle 100. In one embodiment, the sensor system 108 is communicatively coupled to the controller 140 to transfer measurements of the power system 106 to the controller 140. The sensor system 108 may include a current sensor, a voltage sensor, a temperature sensor, or the like.

The controlled contacts 114 can be coupled to the power system 106 and the controller 140. In one embodiment, the controlled contacts 114 can connect to the contacts of the battery cells of the power system 106 to form various charging circuit configurations.

The propulsion system 120 can include an internal combustion engine (ICE) system 122 and at least one electric motor assembly (e.g., a first electric motor 124 and a second electric motor 126). Each component of the propulsion system 120 can be configured to drive at least one the wheels 130 of the vehicle 100 via a transmission system coupled to a front axle shaft or a rear axle shaft, which are coupled to a respective front and rear set of the wheels 130.

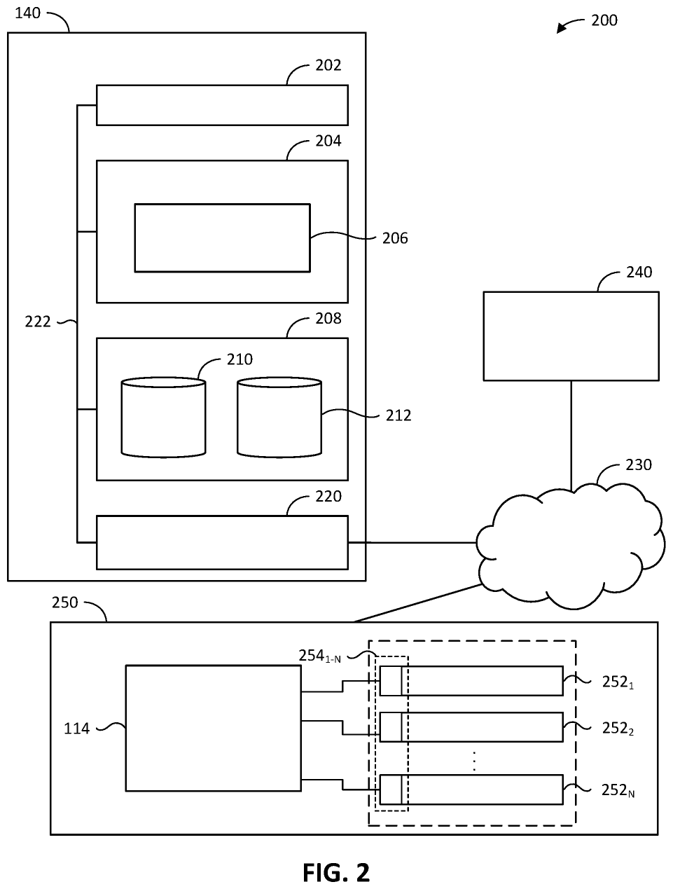

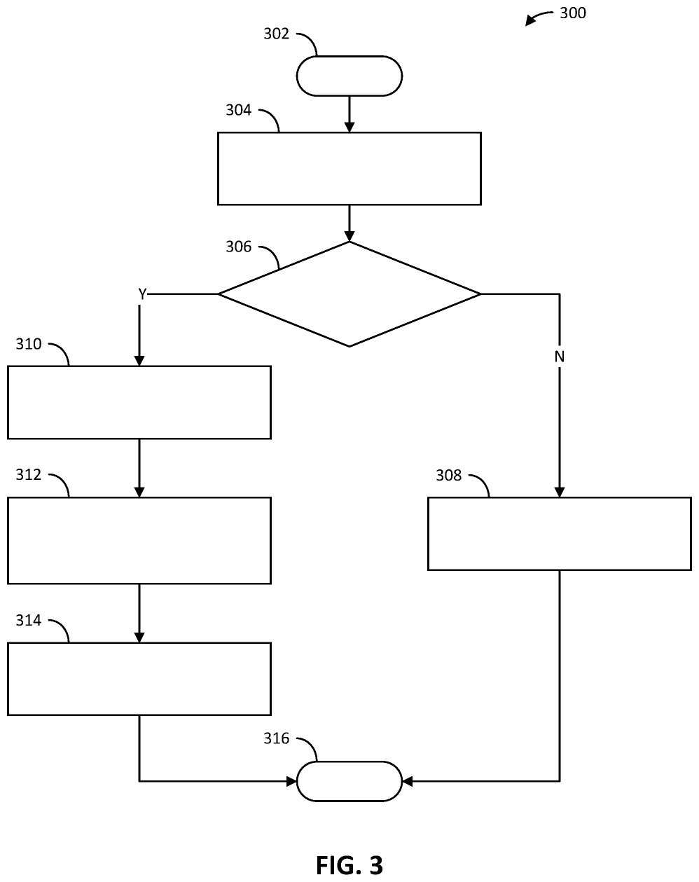

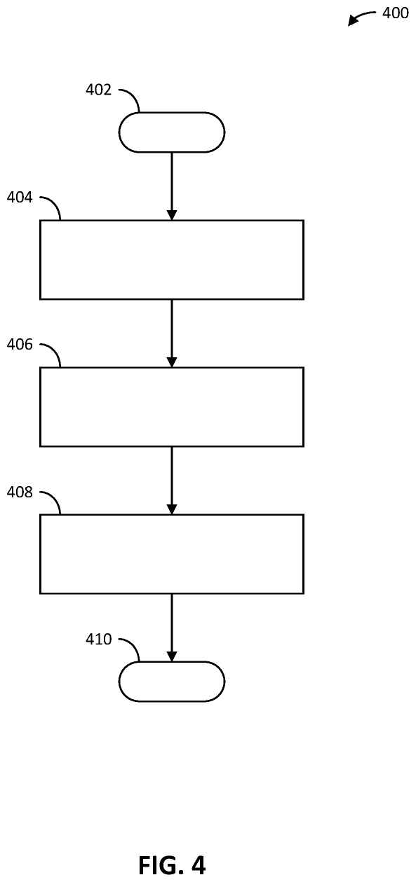

In one embodiment, the controller 140 is configured to control the controlled contacts 114 to generate various charging circuit configurations. The controller 140 is discussed further in FIG. 2. Techniques used to optimize charging via charging circuit configurations are discussed in FIGS. 3 and 4.

FIG. 2 illustrates a computing environment 200, according to an embodiment. In the illustrated embodiment, the computing environment 200 includes a controller 140, a network 230, a charging source 240, and a charging circuit configuration 250.

In one embodiment, the controller 140 includes a processor 202 that obtains instructions and data via a bus 222 from a memory 204 or storage 208. Not all components of the controller 140 are shown. The controller 140 is generally under the control of an operating system (OS) suitable to perform or support the functions or processes disclosed herein. The processor 202 is a programmable logic device that performs instruction, logic, and mathematical processing, and may be representative of one or more CPUs. The processor may execute one or more algorithms, instruction sets, or applications in the memory 204 or storage 208 to perform the functions or processes described herein.

The memory 204 and storage 208 can be representative of hard-disk drives, solid state drives, flash memory devices, optical media, and the like. The storage 208 can also include structured storage (e.g., a database). In addition, the memory 204 and storage 208 may be considered to include memory physically located elsewhere. For example, the memory 204 and storage 208 may be physically located on another computer communicatively coupled to the controller 140 via the bus 222 or the network 230.

The controller 140 can be connected to other computers (e.g., controllers, distributed databases, servers, or webhosts), the charging source 240, or the charging circuit configuration 250 via a network interface 220 and the network 230. Examples of the network 230 include a controller area network (CAN), a transmission control protocol (TCP) bus, charging cables, electrical busses, physical transmission cables, optical transmission fibers, wireless transmissions mediums, routers, firewalls, switches, gateway computers, edge servers, a local area network, a wide area network, a wireless network, or the like. The network interface 220 may be any type of network communications device allowing the controller 140 to communicate with computers and other components of the computing environment 200 via the network 230.

In the illustrated embodiment, the memory 204 includes a charging control module (CCM) 206. In one embodiment, the CCM 206 represents one or more algorithms, instruction sets, software applications, or other computer-readable program code that can be executed by the processor 202 to perform the functions, operations, or processes described herein.

In one embodiment, the CCM 206 determines a capability of the charging source 240 to perform multi-stage charging, and determines an available power of the charging source 240. The CCM 206 can store data of these features of the charging source 240 in the storage 208 as charging data 210. Further, the CCM 206 can receive user input that indicates a charging duration or charging cost limit, and store data of the user input in the storage 208 as user input data 212.

The CCM 206 can further determine features of the RESS, such as an average temperature of the RESS, or a capability of accepting current. Afterwards, the CCM 206 operates the controlled contacts 114 to generate a charging circuit configuration 250 that optimizes charging of the RESS in accordance with the aforementioned features and data.

In the illustrated embodiment, a charging circuit configuration 250 includes the controlled contacts 114, cell groups 252_{1-N}, and respective cell group contacts 254_{1-N}. The controlled contacts 114 can be connected to the cell group contacts 254_{1-N}. The controlled contacts 114 can also include multiple circuit elements and electrical paths that connect the cell groups 252_{1-N} in various combinations to generate corresponding charging circuit configurations. For example, the CCM 206 can control the controlled contacts 114 to connect a first cell group (e.g., cell group 252₁) and a second cell group (e.g., cell group 252₂) in series or in parallel. Hence, one charging circuit configuration 250 may include the first and second cell groups connected in series, and another charging circuit configuration 250 may include the first and second cell groups connected in parallel.

In this manner, the CCM 206 can also generate charging circuit configurations that include any number or combination of the cell groups 252_{1-N}. The cell groups 252_{1-N} may output a given voltage output, which can be aggregated or maintained via the charging circuit configurations. Although embodiments of the present disclosure may describe combinations of a first cell group and a second group, any combination of N number of cell groups may be used.

Continuing the previous example, each cell group may output 400 V. Thus, the charging circuit configuration 250 with the first and second cell groups connected in series can output 800 V, while the charging circuit configuration 250 with the first and second cell groups connected in parallel can output 400 V. Further, the voltage output of a charging circuit configuration 250 can scale with the number of connected cell groups (e.g., 1200 V for 3 cell groups connected in series, 1600 V for 4 cell groups connected in series, etc.). Operations of the CCM 206 are described further in FIGS. 3-4 herein.

FIG. 3 illustrates a flowchart of a method 300 of charging an energy storage system via a first charging circuit configuration, according to an embodiment. The method 300 begins at block 302.

At block 304, the charging control module (CCM) 206 determines a charging stage capability of a charging source 240. In one embodiment, the charging source 240 includes a charging station, another vehicle, a power bank, a grid, or the like. The CCM 206 can use a handshake process to establish a connection with the charging source 240, and negotiate charging parameters (e.g., available power, power level capability, maximum power capability, power rates/costs, voltage transfer limits, current transfer limits, or the like).

At block 306, the CCM 206 determines whether the charging stage capability includes multi-stage charging. Upon determining that the charging stage capability does not include multi-stage charging, the method 300 proceeds to block 308, where the CCM 206 charges a rechargeable energy storage system (RESS) of the vehicle 100 via a single stage DCFC session. The method 300 then proceeds to block 316, where the method 300 ends. However, returning to block 306, upon determining that the charging stage capability includes multi-stage charging, the method 300 proceeds to block 310.

At block 310, the CCM 206 determines a first charging criteria. In one embodiment, the first charging criteria includes at least one of: an available power of the charging source 240, present charging capabilities of the cell groups 252_{1-N}, a user charging duration limit, a user charging cost limit, a temperature of a RESS of the vehicle 100, or an accessory load of the vehicle 100.

At block 312, the CCM 206 selects a first charging circuit configuration based on the first charging criteria. In one embodiment, the CCM 206 limits the selection of the first charging circuit configuration to combinations of the cell groups 252_{1-N} that can be supported by the available power from the charging source 240. For example, assuming that the present available power (e.g., an available voltage supply) of the charging source is 500 V, the CCM 206 may select a parallel charging circuit configuration that can accept 400 V, rather than a series charging circuit configuration that can accept 800 V.

In one embodiment, when a user enters a charging duration limit, the CCM 206 can select a series charging circuit configuration to recharge the vehicle 100 quickly during the specific duration. When the user enters a charging cost limit, the CCM 206 can identify the power rates/costs of the charging source 240, and select a series or parallel charging circuit configuration to maximize the charge supplied by the charging source 240, while remaining below the charging cost limit.

In one embodiment, the charging capabilities of the cell groups 252_{1-N} are affected by the temperature of the cell groups 252_{1-N}. For instance, when a RESS that includes the cell groups 252_{1-N} is in a cold environment, the cell groups 252_{1-N} can be less capable of accepting a charge. In such circumstances, the CCM 206 can select a charging circuit configuration 250 connected in parallel to operate at a lower voltage while generating heat to warm the cell groups 252_{1-N} to a temperature at which the cell groups 252_{1-N} can accept a greater charge. For instance, use of the parallel charging circuit configuration may generate heat along an electrical path of the controlled contacts 114 (which may be coupled to heat sinks or a liquid cooling system), throughout individual cells of the cell groups 252_{1-N}, or in a liquid cooling system at the charge port 104.

The CCM 206 can further consider an accessory load of the vehicle 100. In one embodiment, when the capability of the cell groups 252_{1-N} to accept a charge is low, the accessory load connected to a series charging circuit configuration can use the charge supplied by the charging source to the series charging circuit configuration, thereby reducing the charge available to recharge the connected cell groups. In such circumstances, the CCM 206 may select a parallel charging circuit configuration to prevent the power used by the accessory load (connected in parallel to the cell groups 252_{1-N}) from reducing the power available to the cell groups 252_{1-N} (in comparison with a series charging circuit configuration).

At block 314, the CCM 206 charges the energy storage system via the first charging circuit configuration. The method 300 ends at block 316.

FIG. 4 illustrates a flowchart of a method 400 of charging an energy storage system via a second charging circuit configuration, according to an embodiment. The method 400 begins at block 402.

At block 404, the CCM 206 determines a second charging criteria. In one embodiment, the second charging criteria includes at least one of: an update of the available power of the charging source 240, an update of the present charging capabilities of the cell groups 252_{1-N}, a lapse of time associated with the user input charging duration, an accrued cost associated with user input cost, an update of the temperature of the RESS of the vehicle 100, or an update of the accessory load of the vehicle 100.

In one embodiment, the CCM 206 generates a message that notifies the user of the lapse of time or the accrued cost. The CCM 206 can transfer the message to a display of the vehicle 100, or a user device coupled to the vehicle 100.

At block 406, the CCM 206 selects a second charging circuit configuration based on the second charging criteria. The second charging circuit configuration can be selected using processes similar to the processes described in FIG. 3.

In one embodiment, the selection of the second charging circuit configuration is made upon the occurrence of transition events. Examples of the transition events include: a match between charging capabilities of the first charging circuit configuration and second charging circuit configuration, a match between the charging capability of the second charging circuit configuration and an available power limit or a maximum power output limit of the charging source 240 (e.g., the available power limit may be increased or decreased to match the charging capability of the second charging circuit configuration when another vehicle disconnects or connects to the charging source 240), a reduction of the accessory load of the first charging circuit configuration to a power below a power threshold, an increase of a temperature of the RESS or the cell groups 252_{1-N} above a temperature threshold, a lapse of a specified time duration, or the like.

At block 408, the CCM 206 charges the energy storage system via the second charging circuit. In one embodiment, the first charging circuit configuration and the second charging circuit configuration include different combinations of the cell groups 252_{1-N}, such that selecting the second charging circuit configuration represents switching to a different recharging capability of the vehicle 100 during a single charging session (or during multiple, subsequent charging sessions).

A charging source 240 may require starting a new charging session to switch to a second charging circuit configuration that is different from the first charging circuit configuration. In such circumstances, in one embodiment, the CCM 206 generates a message that instructs the user to re-initiate the session (i.e., disconnect and reconnect a charging cable from the charge port 104). The CCM 206 can transfer the message to a display of the vehicle 100, or a user device coupled to the vehicle 100.

The CCM 206 automatically restarts the charging session. In one embodiment, the vehicle 100 can restart the session by temporarily reducing a voltage via the control pilot communication line. For instance, the charge port 104 can include multiple pins that communicate with the charging source 240. One of the pins can be dedicated to a control pilot signal, which can cause the charging source 240 to reset the session when the voltage falls below a reset threshold.

In another embodiment, the CCM 206 can reduce the power demand from the charging source 240 to OA, to cause the charging source 240 to stop the charging session. Afterwards, the CCM 206 can raise the power demand to match the requirements of the second charging circuit configuration. The method 400 ends at block 410.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for multi-stage charging control of a vehicle, comprising:
determining a charging stage capability of a charging source;
upon determining that the charging stage capability includes multi-stage charging, determining a first charging criteria;
selecting a first charging circuit configuration based on the first charging criteria, wherein the first charging circuit configuration includes a first combination of cell groups of a rechargeable energy storage system of the vehicle; and
charging the rechargeable energy storage system via the first charging circuit configuration.

2. The method of claim 1, further comprising:
determining a second charging criteria;
selecting a second charging circuit configuration based on the second charging criteria, wherein the second charging circuit configuration includes a second combination of cell groups of the rechargeable energy storage system; and
charging the rechargeable energy storage system via the second charging circuit configuration.

3. The method of claim 1, wherein the charging source includes a charging station, another vehicle, a power bank, or a grid.

4. The method of claim 1, wherein the first charging criteria includes at least one of: an available power of the charging source, present charging capabilities of the cell groups, a user charging duration limit, a user charging cost limit, a temperature of the rechargeable energy storage system, or an accessory load of the vehicle.

5. The method of claim 2, wherein the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

6. The method of claim 2, wherein the selection of the second charging circuit configuration is performed upon an occurrence of a transition event, wherein the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

7. The method of claim 2, wherein the first charging circuit configuration represents a 400 V parallel circuit configuration, and wherein the second charging circuit configuration represents an 800 V series circuit configuration.

8. A system for multi-stage charging control of a vehicle, comprising:
a processor; and
memory or storage comprising an algorithm or computer instructions, which when executed by the processor, performs an operation comprising:
determining a charging stage capability of a charging source;
upon determining that the charging stage capability includes multi-stage charge, determining a first charging criteria;
selecting a first charging circuit configuration based on the first charging criteria, wherein the first charging circuit configuration includes a first combination of cell groups of a rechargeable energy storage system of the vehicle; and
charging the rechargeable energy storage system via the first charging circuit configuration.

9. The system of claim 8, the operation further comprising:
determining a second charging criteria;
selecting a second charging circuit configuration based on the second charging criteria, wherein the second charging circuit configuration includes a second combination of cell groups of the rechargeable energy storage system; and
charging the rechargeable energy storage system via the second charging circuit configuration.

10. The system of claim 8, wherein the charging source includes a charging station, another vehicle, a power bank, or a grid.

11. The system of claim 8, wherein the first charging criteria includes at least one of: an available power of the charging source, present charging capabilities of the cell groups, a user charging duration limit, a user charging cost limit, a temperature of the rechargeable energy storage system, or an accessory load of the vehicle.

12. The system of claim 9, wherein the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

13. The system of claim 9, wherein the selection of the second charging circuit configuration is performed upon an occurrence of a transition event, wherein the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

14. The system of claim 9, wherein the first charging circuit configuration represents a 400 V parallel circuit configuration, and wherein the second charging circuit configuration represents an 800 V series circuit configuration.

15. A computer-readable storage medium having a computer-readable program code embodied therewith, the computer-readable program code executable by one or more computer processors to perform an operation for multi-stage charging control of a vehicle, the operation comprising:
determining a charging stage capability of a charging source;
upon determining that the charging stage capability includes multi-stage charging, determining a first charging criteria;
selecting a first charging circuit configuration based on the first charging criteria, wherein the first charging circuit configuration includes a first combination of cell groups of a rechargeable energy storage system of the vehicle; and
charging the rechargeable energy storage system via the first charging circuit configuration.

16. The computer-readable storage medium of claim 15, the operation further comprising:
determining a second charging criteria;
selecting a second charging circuit configuration based on the second charging criteria, wherein the second charging circuit configuration includes a second combination of cell groups of the rechargeable energy storage system; and
charging the rechargeable energy storage system via the second charging circuit configuration.

17. The computer-readable storage medium of claim 15, wherein the first charging criteria includes at least one of: an available power of the charging source, present charging capabilities of the cell groups, a user charging duration limit, a user charging cost limit, a temperature of the rechargeable energy storage system, or an accessory load of the vehicle.

18. The computer-readable storage medium of claim 16, wherein the second charging criteria includes at least one of: an update of an available power of the charging source, an update of a present charging capabilities of the cell groups, a lapse of time associated with a user input charging duration, an accrued cost associated with a user input cost, an update of a temperature of the rechargeable energy storage system, or an update of an accessory load.

19. The computer-readable storage medium of claim 16, wherein the selection of the second charging circuit configuration is performed upon an occurrence of a transition event, wherein the transition event includes one of: a match between a charging capability of the first charging circuit configuration and a charging capability of the second charging circuit configuration, a match between a charging capability of the second charging circuit configuration and an available power limit or a maximum power output limit of the charging source, a reduction of an accessory load of the first charging circuit configuration to a power below a power threshold, an increase of a temperature of the rechargeable energy storage system or the cell groups above a temperature threshold, or a lapse of a specified time duration.

20. The computer-readable storage medium of claim 16, wherein the first charging circuit configuration represents a 400 V parallel circuit configuration, wherein the second charging circuit configuration represents an 800 V series circuit configuration, and wherein the charging source includes a charging station, another vehicle, a power bank, or a grid.
